(19) United States
(12) Patent Application Publication
(10) Pub. No.: US 2004/0034614 A1
(43) Pub. Date: Feb. 19, 2004

(54) Network incident analyzer method and apparatus

(76) Inventors: Michael L. Asher, Green Grove Springs, FL (US); Hossein Eslambolchi, Los Altos Hills, CA (US); Charles C. Giddens, Conyers, GA (US); Christopher Rollin Giles, Auburn, AL (US); John Sinclair Huffman, Conyers, GA (US); Harold Jeffrey Stewart, Alpharetta, GA (US)

Correspondence Address: AT&T CORP., P.O. BOX 4110, MIDDLETOWN, NJ, 07748, US

(21) Appl. No.: 10/212,345

(22) Filed: Aug. 2, 2002

(51) Int. Cl. G06F 7/00

(52) U.S. Cl. 707/1

(57) ABSTRACT

A method and apparatus for consolidating troubleshooting information generated by a variety of troubleshooting systems is presented. A fault occurs in a network. At least one troubleshooting system notifies a network incident analyzer of the fault. A graphical user interface (GUI) is presented to a network operator. The network operator inputs information into the GUI. The information is used in conjunction with the original troubleshooting information to generate a query to a plurality of troubleshooting systems. Updated troubleshooting information is received in the network incident analyzer in response to the queries. The network incident analyzer uses the updated troubleshooting information to update the GUI and ultimately isolate the fault.

### BACKGROUND OF THE INVENTION

1. Field of the Invention

This invention relates to troubleshooting. Specifically, the present invention relates to automated troubleshooting.

2. Description of the Related Art

Modern communication systems include a large variety of complex technologies distributed over a large area. Communication links often carry a substantial amount of traffic from a wide variety of end-users. As a result, when a communication link fails or goes down, a large variety of customers may be impacted. Given the competitive climate in the communication's industry, it is imperative that customer service be returned, as quickly as possible, when a link fails or goes down. As a result, the area of troubleshooting has received more attention.

In addition to complex communication systems, an entire industry of complex troubleshooting systems has evolved. It is not uncommon to find a wide variety of troubleshooting technologies integrated as part of a communications system. These troubleshooting technologies may vary in the way they identify faults, in the way they store and record faults and finally, in the way they report faults. Many of these troubleshooting systems are proprietary and even when they are not proprietary, the troubleshooting systems often do not report information in a consistent format. Therefore, consolidating information from the various troubleshooting technologies, so that an operator can identify a fault, is a substantial effort.

Troubleshooting communication systems has become a complex and interactive task. Quite often in a typical communication system, a large variety of manufacturers' products (e.g. troubleshooting systems) are implemented. As a result, a large variety of support systems are used. For example, the databases used to support a specific manufacturer's product are often different. As a result, operators and technicians who are attempting to troubleshoot faults in communications networks have to be familiar with a large variety of systems.

Quite often, not only does the operator have to access and understand how to interpret data coming from a troubleshooting system; in addition, the operator has to interact with the troubleshooting system, which often requires that the operator input data into the troubleshooting system. This requires an understanding of the input formats for each system, as well as an understanding of the output from the system.

Consolidating information from a wide variety of systems impacts the speed with which an operator can troubleshoot a fault and also introduces more opportunity for error. For example, as operators access different systems, it may require that the operator logon and interface with different types of computer hardware, different types of computer software and navigate different graphical user interfaces. Navigating different troubleshooting systems requires a team of operators that are trained on different technologies. In addition, accessing and correlating information between different troubleshooting systems slows down fault detection and troubleshooting efforts.

In addition to the impact on the speed of fault detection, cross-correlating information between systems may result in inaccurate identification and detection of faults. As mentioned previously, quite often the systems do not interoperate with each other and an operator has to serve as an interface between systems. When an operator serves as an interface, the opportunity for operator error is introduced. In addition, when an operator has to interpret the various types of data coming from each troubleshooting system, the opportunity for operator error once again is introduced. Lastly, the operator may not have access to all of the systems at the same time and may have to rely on other personnel, such as other operators, to acquire additional information for troubleshooting. When a first operator has to depend on a second operator for troubleshooting information, the opportunity for operator failure and human error once again is increased.

Each communication link or geographical area may have a specific troubleshooting system used for identifying faults within a communication network. Each troubleshooting system may include separate technology for identifying a fault and a separate database for storing information about the fault. Lastly, a separate mechanism for alerting operators to the faults may also be present. As a result of the wide variety of troubleshooting systems and troubleshooting formats, faults are often inaccurately identified, improperly stored and operators are often alerted to faults that are not there.

Thus, there is a need for troubleshooting faults within a communication network. There is a need for accurately identifying and locating faults within a communications network. There is a need for consolidating the various fault detection and reporting technologies located in a network.

### SUMMARY OF THE INVENTION

A method and apparatus for consolidating troubleshooting information from a variety of troubleshooting systems is presented. In one embodiment of the present invention a method of troubleshooting comprises the steps of receiving troubleshooting information; generating analyzed information by analyzing the troubleshooting information; generating a graphical user interface in response to the troubleshooting information; receiving operator input information in response to generating the graphical user interface; generating a query in response to the analyzed information and in response to the operator input information; receiving updated troubleshooting information in response to the query; and displaying an updated graphical user interface in response to the updated troubleshooting information. In additional embodiments of the present invention, the query is directed to a database of customers impacted; the query is directed to a database of T3's (e.g. communications links) failed; the query is directed to a database of assets available to restore users; the query is directed to a database of drawings; the query is directed to a database of trouble tickets; the query is directed to a database of fiber assignments.

A method of isolating a fault comprises the steps of receiving troubleshooting information from a plurality of different troubleshooting systems; generating a query in response to the troubleshooting information; receiving updated troubleshooting information in response to generating the query; and displaying a fault in response to the updated troubleshooting information.

A method of determining a fault, comprises the steps of receiving troubleshooting information from a variety of troubleshooting systems; consolidating the troubleshooting information; and displaying a fault in response to consolidating the troubleshooting information.

A method of determining a fault, comprises the steps of receiving troubleshooting information; consolidating the troubleshooting information; generating a query in response to consolidating the troubleshooting information; receiving a response to the query; and displaying a fault in response to receiving the response to the query.

### BRIEF DESCRIPTION OF THE DRAWINGS

FIG. 1 is a multi-function computer architecture implementing a method and apparatus of the present invention.

FIG. 2 is a network architecture implementing a method and apparatus of the present invention.

FIG. 3 is a flow diagram of a method of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

A method and apparatus for troubleshooting faults in a communication network is presented. Individual troubleshooting systems identify and record fault information. The fault information is direct to a network incident analyzer that consolidates and displays the fault information in a consistent format for a network operator. During an interactive portion of the troubleshooting process, a network operator is able to input information into the network incident analyzer and the information is used to query the individual troubleshooting systems. In addition, based on the fault information returned from the queries, the individual troubleshooting system updates the consolidated information for reporting or display. In addition, the network incident analyzer includes logic and routines that may vary and redirect queries to various troubleshooting systems. As a result, the network incident analyzer may respond to troubleshooting information, perform logical analysis of the troubleshooting information and further more accurately identify a fault.

In one method and apparatus of the present invention a large variety of troubleshooting systems are accessed. Each of these troubleshooting systems may include a mechanism for identifying a fault, a mechanism for recording the fault and a mechanism for reporting the fault. For example, a troubleshooting system may be implemented in a multi-purpose computing device running specific computer instructions or software. Each troubleshooting system may include specific interfaces for receiving input and for providing output to a network. As a result, when a fault occurs, troubleshooting information may be received on the interface. The troubleshooting information may be logged in a database associated with the troubleshooting system. The database may be any type of database for storing data associated with a fault. It should be appreciated that in the method and apparatus of the present invention, a wide variety of troubleshooting systems are within the scope of the teachings of the present invention.

For example, a troubleshooting system may have a reporting capability or may have an integrated interface for receiving troubleshooting information and outputting troubleshooting information. In addition, a troubleshooting system may be portable and perform troubleshooting under the direction of an operator or a troubleshooting system may be an automated system that constantly monitors a network and automatically identifies and reports a fault. Alternatively, the troubleshooting system may be a proprietary. As such, data may be acquired, recorded and reported using proprietary technologies and proprietary methods.

In one embodiment of the present invention, the network incident analyzer is used to consolidate information from a wide variety of troubleshooting systems. The troubleshooting systems may include information that identifies, records, and alerts an operator to different types of faults in the network. For example, troubleshooting systems may track and report the number of T3 communication links that have failed, the customers impacted, the fiber assignments associated with a fault, personnel available to address the fault, the trouble tickets associated with a fault, the restoration technology available for use and computer aided design (e.g., CAD) drawings of the fault area.

In one method of the present invention, a failure is identified and reported to the network incident analyzer. Data is acquired from and provided to various troubleshooting systems. A uniform consolidated graphical user interface (GUI) is created within the network incident analyzer. Key personnel available for troubleshooting faults in that specific area are identified and contacted. All actions performed to troubleshoot the fault, whether from key personnel or from other operator personnel, is logged and maintained.

The network incident analyzer may be implemented with proprietary technology or the network incident analyzer may be implemented with a multi-purpose computing device operating under computer instructions, such as computer software. For example, the network incident analyzer may be implemented with a multi-purpose computer connected to a network, which receives and outputs troubleshooting information from and to each troubleshooting system across the network.

The network incident analyzer may include a processor operating under computer instructions. The computer instructions may provide the logic for receiving troubleshooting information, analyzing the troubleshooting information and querying various troubleshooting systems in response to the troubleshooting information. Further, the network incident analyzer may include a variety of software components, such as browser software. In one embodiment of the present invention, computer instructions are used to format troubleshooting information received from the various troubleshooting systems and format the troubleshooting information into a GUI using a browser.

The method and apparatus of the present invention may be implemented using a multi-function computer. For example, the trouble-shooting system and the network incident analyzer may be implemented in a multi-function computer running computer instructions or software. In addition, the GUI (e.g., such as an Internet browser) may be implemented using computer instructions implemented in a multi-function computer.

The network incident analyzer receives fault information from troubleshooting systems alerting the network incident analyzer of a fault. The network incident analyzer consolidates the fault information, analyzes the fault information and generates queries based on the fault information. The network incident analyzer receives fault information from a variety of troubleshooting systems. As a result, routines in the network incident analyzer consolidate the fault information into a meaningful format for analysis and display. The consolidation includes receiving the fault information from different troubleshooting systems, reformatting the fault information when necessary and formatting the fault information for display in a GUI.

The fault information is consolidated after receipt on one interface or on multiple interfaces in the network incident analyzer. The fault information is reformatted using a translator in the network incident analyzer. The translator receives fault information in the native format of the troubleshooting system and reformats the fault information into a format of the network incident analyzer. For example, the translator may receive a flat file with information delimited by periods and commas and translate that information into hypertext markup language (e.g., HTML) for display in a GUI (e.g., a browser).

Routines in the network incident analyzer may then analyze the fault information. The analysis includes launching a set of instructions (e.g., routines) in the network incident analyzer that processes the fault information. The routines may parse through the fault information to further define the fault. In the alternative, the routines may parse through the fault information and generate a query. In addition, the network incident analyzer may receive input from an operator to further analyze the fault information. Therefore, in one embodiment of the present invention, the routines in conjunction with operator input are used analyze the fault information.

The routines in the network incident analyzer includes logic (e.g., computer instructions or hardware), which allows the network incident analyzer to formulate queries based on the fault information. In addition, the network incident analyzer accepts operator input, such as operator queries. Lastly, a combination of operator queries and network incident analyzer queries may be implemented. For example, in one embodiment of the present invention, if the fault information includes information on a cable segment that is affected, the network incident analyzer will include routines that will query troubleshooting databases for the assets available to restore the fault or databases including drawings of the fault location. Further, based on the location of the fault, an operator may input a query that provides information on the assets available to restore a fault or provides information on the drawings of the fault area.

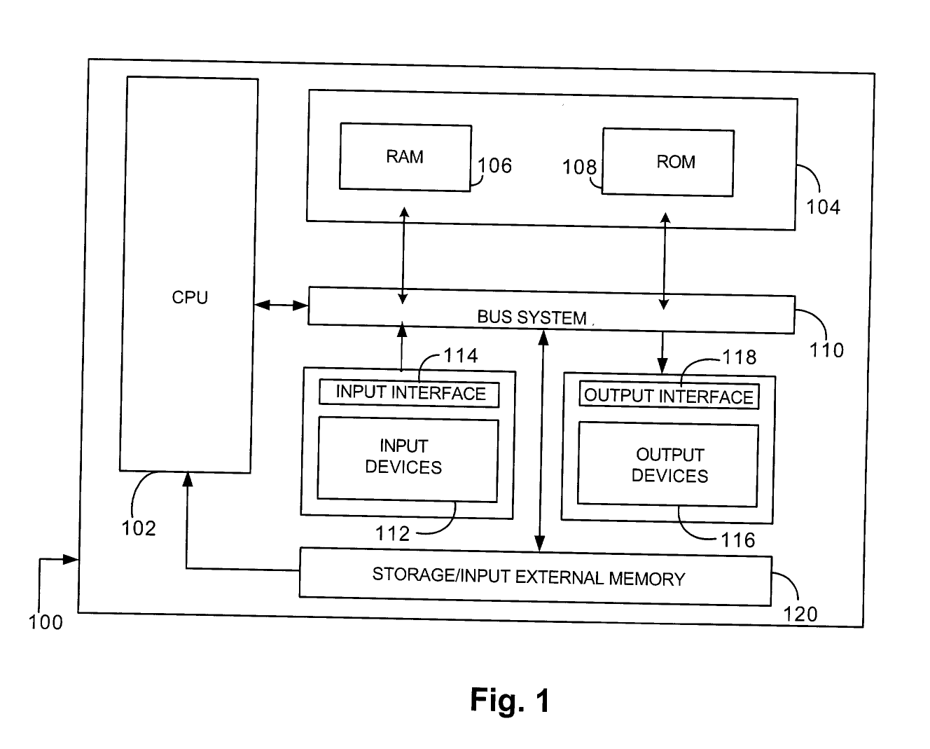

In the present invention, the network incident analyzer may be implemented using a combination of client and server technology implemented with hardware, software or a combination of the two. FIG. 1 is a multi-function computer architecture implementing a method and apparatus of the present invention. In FIG. 1, a central processing unit (CPU) 102 functions as the brains of the multi-function computer 100. Internal memory 104 is shown. The internal memory 104 includes short-term memory 106 and long-term memory 108. The short-term memory 106 may be Random Access Memory (RAM) or a memory cache used for staging information. The long-term memory 108 may be a read only memory or an alternative form of memory used for storing information. A bus system 110 is used by the CPU 102 to control the access and retrieval of information from short-term memory 106 and long-term memory 108.

Input devices, such as joystick, keyboards, microphone or a mouse are shown as 112. The input devices 112 interface with the system through an input interface 114. The input devices 112 may include input interfaces, which assess faults in a network. For example, the input devices 112 may include a network monitor that is connected to a network and monitors faults in the network. In addition, an input interface 112 may include a network interface for receiving troubleshooting information from a troubleshooting system.

Output devices, such as a monitor, speakers, etc. are shown as 116. The output devices 116 interface with the multi-function computer 100 through an output interface 118. The output devices 116 may include an interface for outputting queries across a network to a troubleshooting system.

External memory, such as a hard drive, is shown as 120. The hard drive 120 may store browser software used to display a GUI on an operator screen. In addition, the hard drive may include software instructions for implementing the logic (e.g., operations) of the network incident analyzer. The software instructions cause the multi-function computer to receive troubleshooting information, analyze the troubleshooting information, query troubleshooting systems and display/update a GUI based on the troubleshooting information.

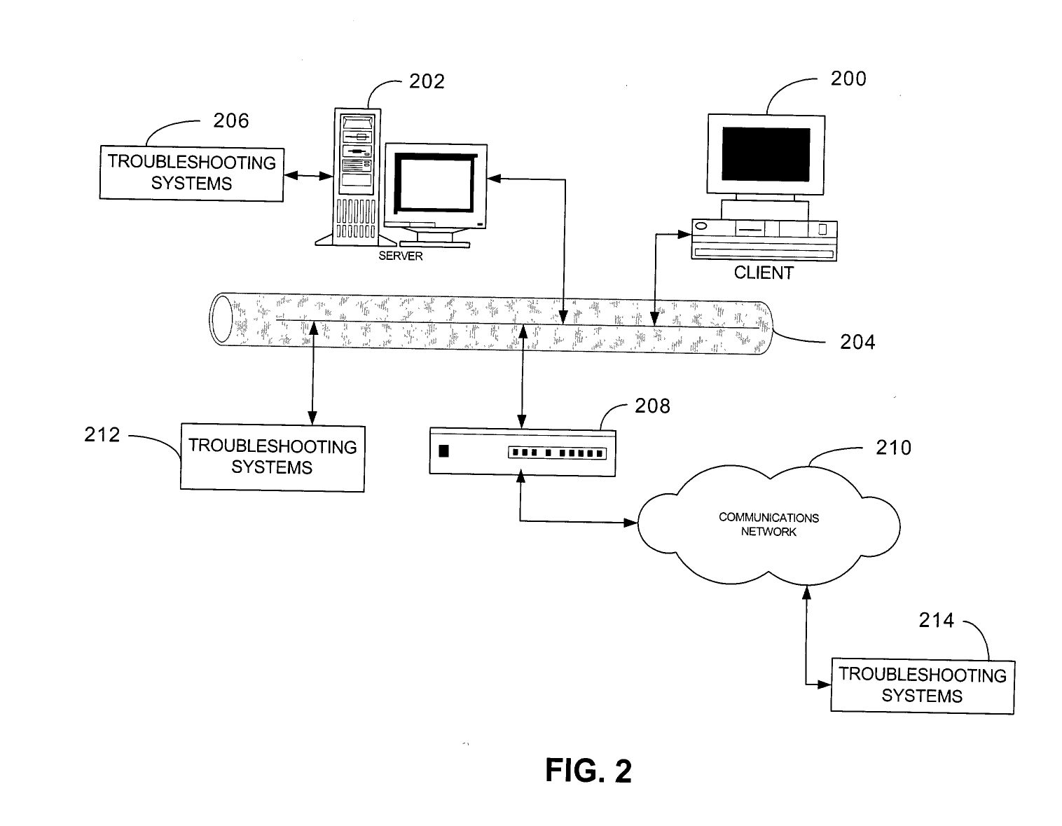

FIG. 2 is a network architecture implementing a method and apparatus of the present invention. A network incident analyzer implemented in accordance with the teachings of the present invention may be implemented in a client machine, a server machine or in a client-server combination. In FIG. 2, a client machine is shown as 200, the client machine may be a multi-purpose computer. The client machine may run computer software, such as browser software and graphically display troubleshooting information. For example, the client machine 200 may display a map showing the location of a fault or provide an operator with input fields for inputting queries.

The network incident analyzer may be implemented in a variety of configurations. For example, client machine 200 may function as the network incident analyzer, server machine 202 may function as the network incident analyzer or a combination of client machine 200 and server machine 202 may function as the network incident analyzer. In each of these configurations, the network incident analyzer may function as a troubleshooting system, which is directly connected to troubleshooting systems or which communicates across a network with troubleshooting systems.

In one embodiment of the present invention, the network incident analyzer may be implemented in client machine 200. As such, client machine 200 may be connected to a network, such as 204 or another network (not shown) through an interface. As a result, client machine 200 may be used to consolidate troubleshooting information from the respective networks.

Client machine 200 may communicate with server 202 across a local area network 204, such as an Ethernet connection. As such, a network incident analyzer may be implemented between client machine 200 and server 202. Lastly, server 202 may function as a network incident analyzer. For example, server 202 may be directly connected to a troubleshooting system or server 202 may receive information across a network from troubleshooting systems shown as 206, 212 and 214. Server 202 may then store the troubleshooting information in a database and communicate the information to client machine 200 for display in a GUI.

In the method and apparatus of the present invention, the network incident analyzer consolidates information from a number of disparate troubleshooting systems. In addition, the network incident analyzer itself may function as a troubleshooting system.

Troubleshooting systems 206, 212 and 214 are shown. In one embodiment of the present invention, a troubleshooting system, such as 206, may connect directly to the network incident analyzer and communicate troubleshooting information directly to the network incident analyzer. In another embodiment of the present invention, a troubleshooting system, such as troubleshooting system 212, may communicate with a network incident analyzer across a network, such as a local area network shown as 204. In another embodiment of the present invention, a troubleshooting system, such as 214, may communicate across a communications network, such as 210, across a communications device 208 and then across a local area network 204, to the network incident analyzer (200, 202). The communications network 210 may be any type of communications network, such as a packet switching network or a circuit-switching network. The communications device 208 may be any type of communications device, such as a bridge, a router or a hub.

During operations each troubleshooting system receives troubleshooting information. The information is communicated to the network incident analyzer (200, 202). The network incident analyzer consolidates the information and presents the troubleshooting information in a GUI format for display and analysis by an operator. The network incident analyzer also contains computer instructions or routines. As the troubleshooting information is received in the network incident analyzer, queries are constructed based on the troubleshooting information. The queries are communicated from the network incident analyzer back to the troubleshooting systems. For example, the network incident analyzer may communicate troubleshooting information across the network back to the troubleshooting system. The troubleshooting system will respond to the queries from the network incident analyzer. The network incident analyzer receives the response to the queries and uses logic implemented in computer routines to isolate the fault and dispatch operators to fix the fault.

An operator has interaction with the network incident analyzer. In addition, the network incident analyzer structures and composes queries based on the troubleshooting information coming from troubleshooting systems. For example, as troubleshooting information comes in from troubleshooting systems, the network incident analyzer stores and analyzes the troubleshooting information. Based on the analysis, the network incident analyzer composes, generates and communicates queries out to the troubleshooting systems. In addition, the network incident analyzer displays graphical information for operator review. The operator may interact with the GUI provided by the network incident analyzer and input information into the network incident analyzer. The network incident analyzer uses the operator input in conjunction with the troubleshooting information coming from the troubleshooting systems to formulate queries.

In one embodiment of the present invention, the network incident analyzer receives troubleshooting information from a troubleshooting system. The network incident analyzer formulates the troubleshooting information into a GUI for presentation to an operator. The operator interacts with the GUI and inputs information into the network incident analyzer. The network incident analyzer combines the operator input with the troubleshooting information and formulates a query. The query is then send to the troubleshooting system(s). The troubleshooting system responds to the query with updated troubleshooting information, which is providing back to the network incident analyzer. The network incident analyzer uses the updated troubleshooting information to update the GUI presented to the operator and isolates a fault. It should be appreciated that many variations of the foregoing method may be implemented and still remain within the scope of the present invention.

In one embodiment of the present invention, initial information will be communicated from a troubleshooting system to the network incident analyzer. The initial information may include a communication link that has a fault. The network incident analyzer will display a map of the area including the communication link within a browser or some other kind of GUI. In addition to a map of the fault location, the GUI may also include a query box for receiving queries. Both the map and the query box may be resized to accommodate different types of queries and analysis. As such, the query box may allow an operator to input commands, which cause the network incident analyzer to zoom into specific areas on the map or zoom out of specific areas on the map, as well as refocus on different areas of the map. In addition, a graphical interface may be provided, such as a box, which enables an operator to zoom into a location, zoom out of a location or refocus on a location. It should be appreciated that in the method and apparatus of the present invention, a variety of inputs and graphical tools may be implemented to manipulate processing in the network incident analyzer and consequently the GUI.

In one embodiment of the present invention, the query box is an input location in the GUI for receiving a predefined system of queries or in the alternative the query box may include a translator, such as a natural language translator for translating a variety of previously undefined queries. It should also be appreciated that queries may be implemented by other means, such as with a pull down menu located within the GUI.

A variety of queries may be placed within the query box. Once a query is input into the query box the query is received by a translator located in the network incident analyzer. The translator translates the query into a format that is understandable by a troubleshooting system that will respond to the query. The query is then forwarded to the troubleshooting system for a response. Once a response to the query returns back to the network incident analyzer, the translator within the network incident analyzer reformats the query response and either performs further processing on the query response or updates the GUI in response to the query response. The queries are posted to different troubleshooting systems. For example, some troubleshooting systems include trouble tickets, fiber assignments, T3's failed, customers impacted, human resources, network assets associated with a fault, and computer-aided design drawings associated with a fault. However, it should be appreciated that a number of other troubleshooting systems may be queried.

In one embodiment of the present invention, a trouble ticket troubleshooting system is implemented. Once operator personnel have defined a potential fault area, a query is posted to a trouble ticket database in a trouble ticket troubleshooting system. The troubleshooting database maintains all tickets associated with all of the faults in a network for a specific area. For example, a trouble ticket database may include the date and time of the network fault, the trouble ticket number associated with the network fault, the operator or technician that opened the trouble ticket, the address of the network faults as well as other information associated with the trouble ticket. A “get tickets” command is a query that is input into the network incident analyzer that causes the network incident analyzer to query the trouble ticket database associated with the faults. The trouble ticket database then returns the trouble ticket associated with the specific fault to the network incident analyzer for further processing and display.

Fiber cable assignments associated with each link in a communications network are maintained in a database. The “get fiber assignments” query will query the database that stores the fiber assignments associated with a particular trouble ticket and a particular fault location. In one embodiment of the present invention, the fiber assignments database will return all the fiber assignments associated with the area in which the fault is located. As the area of a fault location is expanded, additional fiber assignments may be provided through the get fiber assignments query. The fiber assignments query will produce troubleshooting information, which includes all of the fibers, which have failed but have not been restored. In one embodiment of the present invention as each fiber is physically restored a graphical icon displays next to a fiber assignments entry which is provided in response to the get fiber assignments query.

A database is maintained on each T3 within the communications network. When a “get T3 failed” query is initiated, a listing of all of the T3s that have failed as a result of the fault is provided to the network incident analyzer. During operations, the number of T3's failed and restored will continually be provided to the network incident analyzer, so that this information can be updated by the network incident analyzer.

A database of all the customers associated with different aspects of the communications network is maintained. Therefore, the specific customers associated with a fault or a T3 that failed can be provided to the network incident analyzer. This information is critical to identify key customers, major groups of customers or uniquely positioned customers. A “get customers impacted” query is implemented by the network incident analyzer. The “get customers impacted” query produces the customers that have been impacted by the fault.

A database of the network operators and technicians associated with a specific area is maintained. A “get human resources” query may be initiated by the network incident analyzer. The get human resources query determines what field technicians are available based on predefined maintenance territories. The human resources information may include information, such as supervisory responsibilities, technicians schedules, assigned backups, and in the event a vendor was assigned to the area, will provide contact information on the vendor. If the area has a restoration contractor assigned, the company and contact information for the restoration contractor will be identified. Automatic notification will be made to the assigned restoration contractor. In addition, automatic notification of technicians and supervisors in the immediate area will be initiated. The automatic notification can be done automatically, once the area is defined. Other communications systems can then be used to call and/or identify personnel and provide confirmation of receipt of notification to the network incident analyzer.

A database is maintained of each outside asset associated with a fault location and fault location area. The network incident analyzer may launch a “get assets” query. The get assets query database includes information about fiber restoration equipment. Some of the information may include equipment types located on trucks and buildings, such as Optical Time Domain Reflectometers (OTDR) spare wheels of fiber, etc.

A database of computer-aided design drawings associated with each network is also maintained. A “get drawings” query is used to access the database of computer-aided design drawings. The get drawings query will request information from client engineering and construction tables to retrieve and build CAD information that might be available for the area. Since the initial fault location may cover several miles, many drawings will be identified. As the fault location is isolated, drawings that are no longer candidates will be removed.

It should be appreciated that while specific queries have been identified, a large variety of queries may be implemented and still remain within the scope of the present invention. The queries may be static queries or dynamic queries implemented using natural language processors. The queries may be generated by the network incident analyzer, the operator or a combination of the two. The queries are communicated from the network incident analyzer to the troubleshooting system(s). The queries may be formatted in a compatible format for the troubleshooting system before transmission to the troubleshooting system(s) or the troubleshooting system(s) may reformat the query into a native format once the query is received. In one embodiment of the present invention, standardized database query formats such as Structured Query Language (SQL) may be implemented in another embodiment of the present invention the queries may be implemented in a proprietary query language.

Once the query is received by a database associated with the troubleshooting system, the database (e.g., database server) responds to the query. The network incident analyzer receives the query response and processes the information for display or the network incident analyzer generates additional queries. The network incident analyzer may produce a single query in response to fault notification or may generate multiple queries. The queries may be directed to the troubleshooting system that notified the network incident analyzer of the fault or the queries may be directed to another troubleshooting system.

The response to one or several queries may return to the network incident analyzer. Multiple responses may come from a single troubleshooting system or from multiple troubleshooting systems. The network incident analyzer may wait to receive all of the responses to perform further analysis or perform analysis and processing as each query is received.

The response to queries may be consolidated and analyzed to generate new query information or to update the GUI. Consolidation may include collecting query information from a single troubleshooting system or combining query information from multiple troubleshooting systems. In addition, consolidation of information may occur at a single predefined time, once specific information is received or dynamically as information is received. As such, the network incident analyzer engages in an interactive communications session with the troubleshooting systems to isolate and resolve faults.

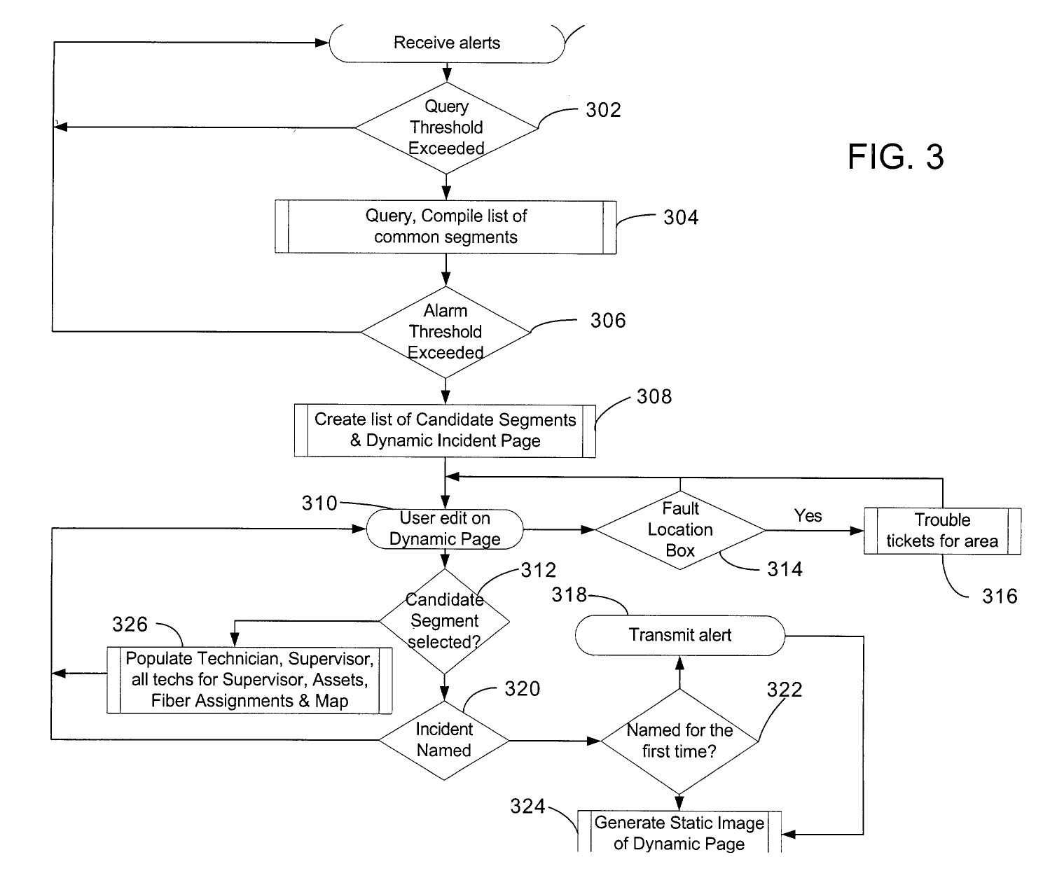

A method of implementing the present invention is shown in FIG. 3. Alarm collection troubleshooting systems send alarm information to the network incident analyzer as shown at item 300. The alarms are collected in the network incident analyzer. During the alert process, another troubleshooting system may look at the ability to restore the components of the network (e.g., cable segments) that are down. For example, a second troubleshooting system may analyze the resources available for routing information around the fault location or restoring the facilities affected by the fault (e.g., network incident).

Failure information (e.g., network incident) is time when the failure information is received by the network incident analyzer. For example, the network incident analyzer may begin a timer to make sure the there is a fault and not a minor glitch or noise in the network. As a result, a time threshold is set, as shown at 302, to determine reported incidences that are actual faults. A cable route may have a multitude of cable sections in the same cable sheath. At 304, a list of the cable segments associated with an incident is compiled. There are two types of cable failures, a partial cable failure or a complete cable failure. During a partial cable failure, a subset of fibers in the cable is affected. During a complete cable failure, all of the fibers in the cable may be affected. At 306, a threshold is set. The threshold is associated with the cable segment. For example, a cable segment may have 100 fibers in the cable. A threshold of 100 may be set for that cable segment. As a result, anything less than 100 may indicate a partial cable failure and anything above 100 or equal to 100 may indicate a complete cable failure.

At 308, a list of segments associated with the fault is presented to an operator in a web page. At 310, the operator may edit the web page by adding or deleting segments or navigating the GUI. For example, a map showing the failed cable segment may be presented. The operator may navigate over to a specific section of the map for closer inspection of the failed cable segment. At 314, a fault (e.g., incident) location box is drawn on the map. The fault location box identifies the location of the fault on the map. The fault location box may be generated by the network incident analyzer. During operation, the fault location box may highlight a specific location on the map. The location on the map may be enlarged by the operator or automatically by the network incident analyzer. At 316, trouble tickets of known work activities in the area of the fault are shown in the GUI.

Assuming that the operator did edit the web page as shown at 310, candidate segments are selected as shown at 312. Once the candidate segments are selected as shown at 312, resources associated with the candidate segments are retrieved from various databases. For example, the technicians and supervisors associated with the area impacted by the candidate segment are identified or the assets, such as fiber assignments and maps associated with the affected area are identified, as shown at 326.

The fault or incident is named for future reference as shown at 320. If the incident is named for the first time (e.g., new incident), as shown at 322, then the network incident analyzer utilizes other systems to send information to the various technicians and support personnel notifying them of the incident as shown at 318. If it is not the first time that the incident has occurred, then an image of the web page associated with the previous activities of the incident are identified, as shown at 324.

Thus, the present invention has been described herein with reference to a particular embodiment for a particular application. Those having ordinary skill in the art and access to the present teachings will recognize additional modifications, applications and embodiments within the scope thereof.

It is, therefore, intended by the appended claims to cover any and all such applications, modifications and embodiments within the scope of the present invention.

What is claimed is:

1. A method of troubleshooting comprising the steps of:
receiving troubleshooting information;
generating analyzed information by analyzing the troubleshooting information;
generating a graphical user interface in response to the troubleshooting information;
receiving operator input information in response to generating the graphical user interface;
generating a query in response to the analyzed information and in response to the operator input information;
receiving updated troubleshooting information in response to the query; and
displaying an updated graphical user interface in response to the updated troubleshooting information.

2. A method as set forth in claim 1, wherein the query is directed to a database of customers impacted.

3. A method as set forth in claim 1, wherein the query is directed to a database of T3's failed.

4. A method as set forth in claim 1, wherein the query is directed to a database of assets available to restore users.

5. A method as set forth in claim 1, wherein the query is directed to a database of drawings.

6. A method as set forth in claim 1, wherein the query is directed to a database of trouble tickets.

7. A method as set forth in claim 1, wherein the query is directed to a database of fiber assignments.

8. A method as set forth in claim 1, wherein the query is directed to a database of customers impacted.

9. An apparatus comprising:
means for receiving troubleshooting information;
means for generating analyzed information by analyzing the troubleshooting information;
means for generating a graphical user interface in response to the troubleshooting information;
means for receiving operator input information in response to generating the graphical user interface;
means for generating a query in response to the analyzed information and in response to the operator input information;
means for receiving updated troubleshooting information in response to the query; and
means for displaying and updated graphical user interface in response to the updated troubleshooting information.

10. A method of isolating a fault comprising the steps of:
receiving troubleshooting information;
generating a query in response to the troubleshooting information;
receiving updated troubleshooting information in response to generating the query; and
displaying a fault in response to the updated troubleshooting information.

11. A method of isolating a fault as set forth in claim 10, wherein the step of generating a query is performed in response to input from an operator.

12. A method of isolating a fault as set forth in claim 10, wherein the step of generating a query is performed in response to processing the troubleshooting information by a network incident analyzer.

13. A method of isolating a fault as set forth in claim 10, wherein the step of generating a query is performed in response to input from an operator and processing the troubleshooting information by a network incident analyzer.

14. An apparatus comprising:
means for receiving troubleshooting information;
means for generating a query in response to the troubleshooting information;
means for receiving updated troubleshooting information in response to generating the query; and
means for displaying a fault in response to the updated troubleshooting information.

15. A method of determining a fault, comprising the steps of:
receiving troubleshooting information from a variety of troubleshooting systems;
consolidating the troubleshooting information; and
displaying a fault in response to consolidating the troubleshooting information.

16. An apparatus comprising:
means for receiving troubleshooting information from a variety of troubleshooting systems;
means for consolidating the troubleshooting information; and
means for displaying a fault in response to consolidating the troubleshooting information.

17. A method of determining a fault, comprising the steps of:
receiving troubleshooting information;
consolidating the troubleshooting information;
generating a query in response to consolidating the troubleshooting information;
receiving a response to the query; and
displaying a fault in response to receiving the response to the query.

18. A method as set forth in claim 17, wherein the response to the query includes information on customers impacted.

19. A method as set forth in claim 17, wherein the response to the query includes information on T3's failed.

20. A method as set forth in claim 17, wherein the response to the query includes information on assets available to restore users.

21. A method as set forth in claim 17, wherein the response to the query includes information on drawings.

22. A method as set forth in claim 17, wherein the response to the query includes information on trouble tickets.

23. A method as set forth in claim 17, wherein the response to the query includes information on fiber assignments.

24. An apparatus comprising:
means for receiving troubleshooting information;
means for consolidating the troubleshooting information;
means for generating a query in response to consolidating the troubleshooting information;
means for receiving a response to the query; and
means for displaying a fault in response to receiving the response to the query.
